(19) United States
(12) Patent Application Publication
(10) Pub. No.: US 2016/0136040 A1
(43) Pub. Date: May 19, 2016

(54) MULTI-FUNCTIONAL MASSAGE MECHANICAL CORE FOR SIMULATING IMPACTS AND VIBRATIONS OF WATER JETS AND CORRESPONDING MASSAGE PRODUCTS

(71) Applicant: Muchun LI, Xiamen, FJ (CN)

(72) Inventor: Muchun LI, Xiamen, FJ (CN)

(21) Appl. No.: 14/541,464

(22) Filed: Nov. 14, 2014

(51) Int. Cl. A61H 23/04

(52) U.S. Cl. CPC A61H 23/04; A61H 2023/045

(57) ABSTRACT

The multi-functional massage mechanical core for simulating impacts and vibrations of water jets comprises a massage motor, a running motor and a heating unit which are connected to a power by an electric control switch to supply electricity. The heating unit is mounted inside a massage surface of a massage core shell assembly. The massage motor and an eccentric wheel are disposed in the massage core shell assembly. The eccentric wheel is mounted on an output axle of the massage motor. The massage core shell assembly is pivotally disposed on a running core shell assembly, and a spring is disposed between the massage core shell assembly and the running core shell assembly. The running motor meshes with a track rack by a gear assembly.

### BACKGROUND OF THE INVENTION

1. Field of the Invention

This invention relates to a massage device, particularly to a mechanical core taking advantage of the motor in cooperation with an eccentric piece to simulate the massaging operation with water impacts and vibrations running from top to down under the setting of the electric control program, fulfilling the fixed-point massage, and fulfilling the heating function, and particularly to a massage product which uses this mechanical core.

2. Description of the Related Art

A mechanical core of a massage apparatus is a crucial part for a massage apparatus. The functions of the massage apparatus depend on the mechanical core. Typically, a conventional massage mechanical core has many structures. The massage mechanical core with different functions also has different structures. The inventor of this invention invents a mechanical core taking advantage of the motor in cooperation with an eccentric piece to simulate the massaging operation with water impacts and vibrations running from top to down under the setting of the electric control program, fulfilling the fixed-point massage and fulfilling the heating function, thereby attaining a multi-functional massage effect.

### SUMMARY OF THE INVENTION

One object of this invention is to provide a multi-functional massage mechanical core for simulating impacts and vibrations of water jets which improves the massage effect.

A further object of this invention is to provide a massage product which provides the better massage effect.

To obtain the above object, the technique of this invention is described as follows:

A multi-functional massage mechanical core for simulating impacts and vibrations of water jets comprises a heating unit, a massage motor, a massage core shell assembly, an eccentric wheel, a running motor, a running core shell assembly, a gear assembly and a track rack. The massage motor, the running motor and the heating unit are connected to a power by an electric control switch to supply electricity. The heating unit is mounted inside a massage surface of the massage core shell assembly. The massage motor and the eccentric wheel are mounted in the massage core shell assembly. The eccentric wheel is mounted on an output axle of the massage motor. The massage core shell assembly is pivotally disposed on the running core shell assembly. A spring is disposed between the massage core shell assembly and the running core shell assembly. The running motor and the gear assembly are mounted on the running core shell assembly. The running motor is in drive connection with the gear assembly. A running gear of the gear assembly meshes with the track rack.

Preferably, the heating unit comprises a PTC heating unit and a LED light so that the PTC heating unit heats and cooperates with the lighting action of the LED light or adopts a bulb directly to obtain the function of lighting and heating.

Preferably, a massage plate is disposed on a massage surface of the massage core shell assembly and locates opposite the heating unit.

Preferably, the massage core shell assembly comprises an upper massage shell and a lower massage shell locked together. The heating unit is mounted on the upper massage shell. The massage motor and the eccentric wheel are mounted between the upper massage shell and the lower massage shell. The running core shell assembly includes an upper running shell and a lower running shell locked together. The running motor and the gear assembly are mounted between the upper running shell and the lower running shell. The lower massage shell is pivotally disposed on the upper running shell by a pivot.

Preferably, the upper running shell comprises a spring hole defined thereon. A spring passes through the spring hole and two ends of the spring are respectively supported against the lower massage shell and the lower running shell.

Preferably, the gear assembly includes a worm gear, a bevel gear, a straight gear and a running gear. The worm gear is mounted on an output axle of the running motor. The worm gear drives the running gear by the bevel gear and the straight gear.

A massage product cooperates with the multi-functional massage mechanical core for simulating impacts and vibrations of water jets. The multi-functional massage mechanical core for simulating impacts and vibrations of water jets is mounted on a back of the massage product and the track rack is mounted on the back from top to bottom.

From above, this invention utilizes the cooperation between the motor and the eccentric piece under the electric control means to obtain the massage function capable of simulating impacts and vibrations of water jets, uses a linear track to fulfill a running massage and a fixed-point massage, and takes advantage of the heating unit to attain a heating massage operation. Therefore, this invention can attain the multi-functional massage and promote the massage effect.

### BRIEF DESCRIPTION OF THE DRAWINGS

FIG. 1 is a perspective view showing this invention; and

FIG. 2 is an exploded view showing this invention.

### DETAILED DESCRIPTION OF THE PREFERRED EMBODIMENTS

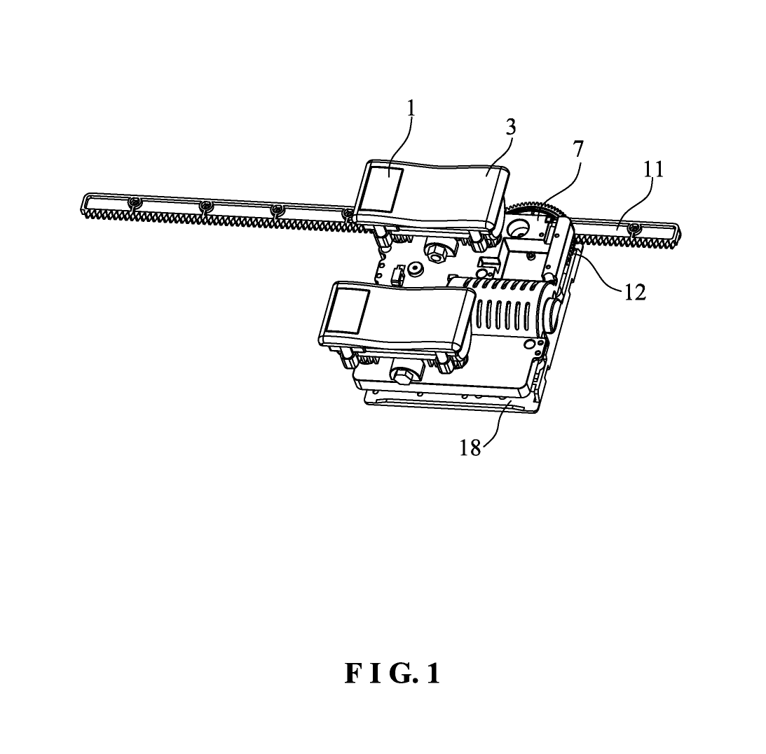

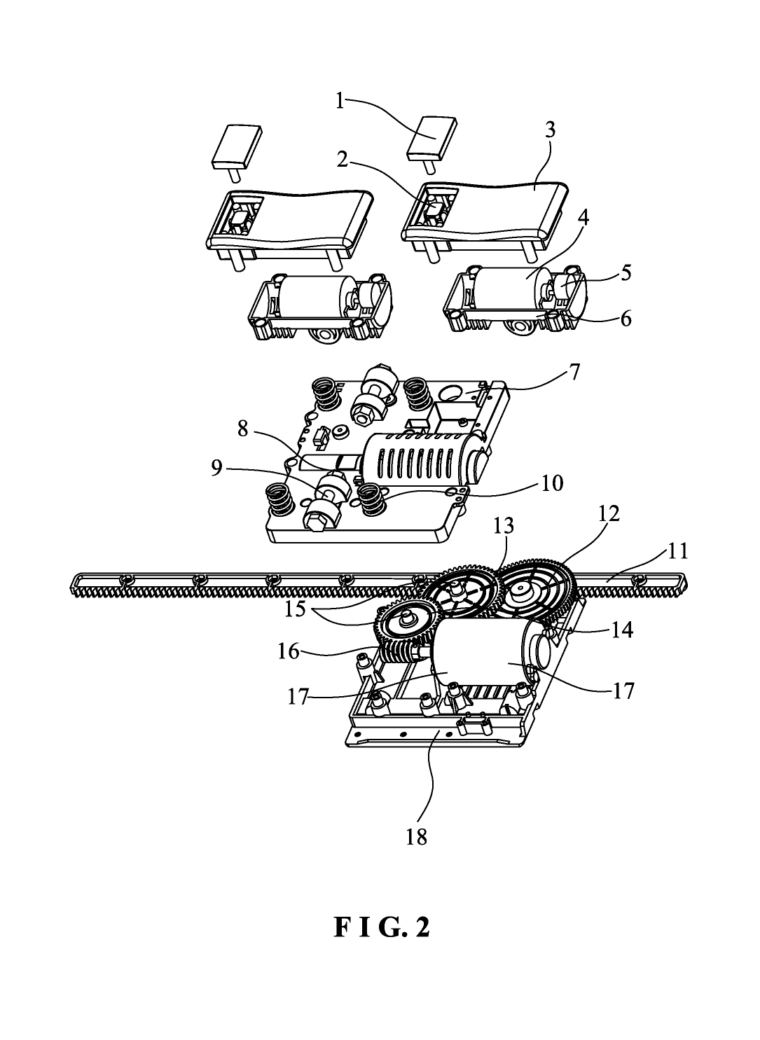

Referring to FIG. 1 and FIG. 2, a multi-functional massage mechanical core for simulating impacts and vibrations of water jets comprises a heating unit 2, a massage motor 4, a massage core shell assembly (comprising an upper massage shell 3 and a lower massage shell 6 locked together), an eccentric wheel 5, a running motor 17, a running core shell assembly (comprising an upper running shell 7 and a lower running shell 18 locked together), a gear assembly (comprising a worm gear 16, a bevel gear 14, a straight gear 13 and a running gear 12) and a track rack 11.

The massage motor 4, the running motor 17 and the heating unit 2 are connected to a power by an electric control switch to supply electricity.

The heating unit 2 is mounted inside a massage surface of the upper massage shell 3 of the massage core shell assembly. A massage plate 1 is mounted on the massage surface of the massage core shell assembly and located opposite the heating unit 2 for promoting the massage effect. The massage motor 4 and the eccentric wheel 5 are mounted between the upper massage shell 3 and the lower massage shell 6 of the massage core shell assembly. The eccentric wheel 5 is mounted on an output axle of the massage motor 4. The lower massage shell 6 of the massage core shell is pivotally mounted on the upper running shell 7 of the running core shell assembly by a pivot (comprising a bolt 9 and an anti-loosening nut 8). At least one spring 10 is disposed between the massage core shell assembly and the running core shell assembly. More precisely, the upper running shell 7 comprises at least one spring hole defined thereon, and the spring 10 passes through the spring hole and two ends of the spring are respectively supported against the lower massage shell 6 and the lower running shell 18.

The running motor 17 and the gear assembly are mounted between the upper running shell 7 and the lower running shell 18 of the running core shell assembly. The running motor 17 is in drive connection with the gear assembly. More precisely, an output axle of the running motor 17 drives the worm gear 16. The worm gear 16 drives the running gear 12 by using the bevel gear 14, the straight gear 13 and a driving shaft 15. The running gear 12 of the gear assembly meshes with the track rack 11.

When the massage mechanical core of this invention is applied to a massage product, the massage mechanical core is mounted on a massage cushion or a chair back. The track rack 11 is mounted on the back from top to bottom, and the track rack 11 is adapted to the human back to attain the better massage effect.

The heating unit 2, using a PTC heating unit in combination with a LED light to emit light or adopting a bulb, is attached to the massage plate 1, whereby the heating unit 2 transmits the heat to the human body and increases the heating function. The LED light or the bulb can emit lights.

The massage motor 4 of this invention drives the rotation of the eccentric wheel 5. The massage motor 4 is fixed between the upper massage shell 3 and the lower massage shell 6 by screws. The lower massage shell 6 is fixed on the upper running shell 7 by using the bolt 9 and the anti-loosening nut 8. Two ends of the lower massage shell 6 are supported by the spring 22 to attain an upward and downward adjustment. When the massage motor 4 rotates, the eccentric piece 5 is rotated by the massage motor 4 so that a centrifugal force is formed by the rotation of the eccentric piece 5 and transmitted from the upper massage shell 3 by the massage motor 4 to the human body. Therefore, this invention attains the massage function with hydraulic pulses by arranging an electric control program system.

This invention attains the fixed-point massage function executed by using the running motor 17 to drive the rotation of the worm gear 16, whereby the worm gear 16 drives the bevel gear 14, the bevel gear 14 drives the straight gear 13 and the straight gear 13 drives the running gear 12. By the running gear 12 which meshes with the track rack 11, this invention obtains the running function. When the running gear 12 stops at a desirable point, the running motor 17 does not work under the control but the massage motor 4 works normally so that a fixed-point massage function is attained.

This invention has a straight running function. The operation is executed by using fasteners to screw the upper running shell 7 to the lower running shell 18. Therefore, the worm gear 16 is rotated by the running motor 17, the bevel gear 14 is driven by the worm gear 16, the straight gear 13 is driven by the bevel gear 14, and the running gear 12 is driven by the straight gear 13. By the running gear 12 which meshes with the track rack 11. So, the structure constructed by engaging the cylindrical wheel structure with the rack attains the straight running massage function.

By comparison with the conventional mechanical core of the massage apparatus, the advantages of this invention are described as follows:

1. This invention comprises the function of simulating hydraulic impacts and vibrations, the heating function, the curved running massage function and the fixed-point massage function. This invention has not only good comfortableness and reliability but also the simple structure and low costs. Further, this invention is easily installed and detached for the production and is easy to operate. The quality of the product can also be guaranteed.

2. The designing principle and the structure of this invention are reasonable. This invention uses the eccentric piece cooperating with an electric control program to simulate a massage effect with hydraulic pulses and vibrations and uses the cylindrical gear to transmit and drive the gear assembly and the rack to attain the up and down running massage function. This invention attains the curved running massage function by working on a curved track. This invention attains the fixed-point massage function by setting the operation of the electric machine and attains the heating function by using the PTC heating unit or the bulb heating means.

This invention is suitable for household or public massage products, such as massage chairs, office chairs, massage beds, massage sofas, massage cushions and foot bathing chairs.

What is claimed is:

1. A multi-functional massage mechanical core for simulating impacts and vibrations of water jets, characterized in that said massage mechanical core comprises a heating unit, a massage motor, a massage core shell assembly, an eccentric wheel, a running motor, a running core shell assembly, a gear assembly and a track rack; wherein said massage motor, said running motor and said heating unit are connected to a power by an electric control switch to supply electricity, said heating unit being mounted inside a massage surface of said massage core shell assembly, said massage motor and said eccentric wheel being mounted in said massage core shell assembly, said eccentric wheel being mounted on an output axle of said massage motor, said massage core shell assembly being pivotally disposed on said running core shell assembly, a spring being disposed between said massage core shell assembly and said running core shell assembly, said running motor and said gear assembly being mounted on said running core shell assembly, said running motor being in drive connection with said gear assembly, a running gear of said gear assembly meshing with said track rack.

2. The multi-functional massage mechanical core for simulating impacts and vibrations of water jets as claimed in claim 1, characterized in that said heating unit includes a PTC heating unit and a LED light or adopts a bulb directly.

3. The multi-functional massage mechanical core for simulating impacts and vibrations of water jets as claimed in claim 1, characterized in that a massage plate is disposed on said massage surface of said massage core shell assembly and located opposite said heating unit.

4. The multi-functional massage mechanical core for simulating impacts and vibrations of water jets as claimed in claim 1, characterized in that said massage core shell assembly comprises an upper massage shell and a lower massage shell locked together, said heating unit being mounted on said upper massage shell, said massage motor and said eccentric wheel being mounted between said upper massage shell and said lower massage shell, said running core shell assembly including an upper running shell and a lower running shell locked together, said running motor and said gear assembly being disposed between said upper running shell and said lower running shell, said lower massage shell being pivotally disposed on said upper running shell by a pivot.

5. The multi-functional massage mechanical core for simulating impacts and vibrations of water jets as claimed in claim 4, characterized in that said upper running shell comprising a spring hole defined thereon, a spring passing through said spring hole and two ends of said spring being respectively supported against said lower massage shell and said lower running shell.

6. The multi-functional massage mechanical core for simulating impacts and vibrations of water jets as claimed in claim 1, characterized in that said gear assembly includes a worm gear, a bevel gear, a straight gear and said running gear, said worm gear being mounted on said output axle of said running motor, said worm gear driving said running gear by said bevel gear and said straight gear.

7. A massage product cooperating with the multi-functional massage mechanical core for simulating impacts and vibrations of water jets as claimed in claim 1, characterized in that said multi-functional massage mechanical core for simulating impacts and vibrations of water jets is mounted on a back of said massage product, said track rack being mounted on said back from top to bottom.
